(19) United States
(12) Patent Application Publication
(10) Pub. No.: US 2012/0024005 A1
(43) Pub. Date: Feb. 2, 2012

(54) BEVERAGE COOLER

(75) Inventors: Raffi Kouyoumdjian, Alamo, CA (US); Robert Petner, Burlington, NJ (US)

(73) Assignee: Raffi Kouyoumdjian, Alamo, CA (US)

(21) Appl. No.: 13/019,708

(22) Filed: Feb. 2, 2011

Related U.S. Application Data
(63) Continuation-in-part of application No. 12/847,009, filed on Jul. 30, 2010.

(51) Int. Cl. F25D 3/00; B23P 19/04

(52) U.S. Cl. 62/457.5; 29/428

(57) ABSTRACT

A beverage cooler for cooling one or more beverages and a method for assembled the beverage cooler are disclosed herein. The beverage cooler includes a frame member having a cooling chamber defined within at least a portion of the frame member, and a beverage support surface that is mounted with respect to the frame member for movement between a deployed position and a retracted position. In the deployed position of the beverage support surface, the beverage support surface is positioned to support at least one beverage container. In the retracted position of the beverage support surface, the beverage support surface is not positioned to support at least one beverage container.

### CROSS-REFERENCE TO RELATED APPLICATIONS

This application is a continuation-in-part patent application of U.S. patent application Ser. No. 12/847,009, filed Jul. 30, 2010, the contents of which are incorporated by reference herein.

### FIELD OF THE INVENTION

The invention is directed to a beverage cooler.

### BACKGROUND OF THE INVENTION

Six-pack sized carriers for canned or bottled beverages are known. There are carriers available with liquid cooling agent that can be either frozen or refrigerated prior to use such as that disclosed in U.S. Pat. No. 7,240,514, which is incorporated herein by reference.

### SUMMARY OF THE INVENTION

According to one aspect of the invention, a beverage cooler includes a frame member having a cooling chamber defined within at least a portion of the frame member, and a beverage support surface that is mounted with respect to the frame member for movement between a deployed position and a retracted position. In a deployed position of the beverage support surface, the beverage support surface is positioned to support at least one beverage container. In a retracted position of the beverage support surface, the beverage support surface is not positioned to support at least one beverage container.

According to another aspect of the invention, a method of assembling a beverage cooler is provided. The method comprises the step of mounting a beverage support surface onto a frame member of the beverage cooler for movement between a deployed position and a retracted position. In the deployed position of the beverage support surface, the beverage support surface is positioned to support at least one beverage container. In the retracted position of the beverage support surface, the beverage support surface is not positioned to support at least one beverage container.

### BRIEF DESCRIPTION OF THE DRAWINGS

The invention is best understood from the following description when read in connection with the accompanying drawings. It is emphasized that, according to common practice, the various features of the drawings are not to scale. On the contrary, the dimensions of the various features may be arbitrarily expanded or reduced for clarity. Included in the drawings are the following figures:

FIG. 1 depicts a perspective view of a beverage cooler according to one exemplary embodiment of the invention, wherein the beverage cooler is shown in a deployed configuration.

FIG. 2 depicts a perspective view of the beverage cooler of FIG. 1 in a partially collapsed configuration.

FIG. 3A depicts a front elevation view of the beverage cooler of FIG. 1 in a collapsed configuration.

FIG. 3B depicts a right side elevation view of the beverage cooler of FIG. 1 in a collapsed configuration.

FIG. 3C depicts a top plan view of the beverage cooler of FIG. 1 in a collapsed configuration.

FIG. 4 depicts a front elevation view of the beverage cooler of FIG. 1, wherein the beverage cooler is shown in a deployed configuration and populated with beverage containers.

FIG. 5 depicts a right side elevation view of the populated beverage cooler of FIG. 4.

FIG. 6 depicts a bottom plan view of the populated beverage cooler of FIG. 4.

FIG. 7 depicts a front elevation view of the frame member of the beverage cooler of FIG. 1.

FIG. 8 depicts a right side elevation view of the frame member of FIG. 7.

FIG. 9 depicts a cross-sectional view of the frame member of FIG. 7 taken along the lines 9-9.

FIG. 10 depicts a cross-sectional view of the frame member of FIG. 7 taken along the lines 10-10.

FIG. 11 depicts a top plan view of the populated beverage cooler of FIG. 4 populated with beverage containers.

FIG. 12 depicts a cross-sectional view of the populated beverage cooler of FIG. 4 taken along the lines 12-12, wherein the beverage housing has been omitted.

FIG. 13 depicts an exploded view of the beverage cooler of FIG. 1 illustrating how the cloth frame is coupled to the frame member.

FIG. 14 depicts a right side elevation view of a beverage cooler according to another exemplary embodiment of the invention, wherein the beverage cooler is shown in a deployed configuration and populated with beverage containers.

FIG. 15 depicts a perspective view of the beverage cooler of FIG. 14 in a deployed configuration wherein the beverage containers and portions of the beverage housing have been omitted to reveal other details of the beverage cooler.

FIG. 16 depicts a right side elevation view of the beverage cooler of FIG. 15 wherein the beverage cooler is shown in a collapsed configuration.

FIG. 17 depicts a perspective view of the hinge portion of the beverage housing of FIG. 14.

FIGS. 18 and 19 depict a perspective view and a side elevation view, respectively, of a beverage cooler according to another exemplary embodiment of the invention.

FIGS. 20 and 21 depict a perspective view and a top plan view, respectively, of a partially assembled beverage cooler of FIG. 18, wherein the beverage support members are shown in a horizontal, deployed position.

FIG. 22 depicts a perspective view of the partially assembled beverage cooler of FIG. 20, wherein one beverage support member is shown in a horizontal, deployed position and the other beverage support member is shown in a vertical, retracted position.

### DETAILED DESCRIPTION OF THE DRAWINGS

Although the invention is illustrated and described herein with reference to specific embodiments, the invention is not intended to be limited to the details shown. Rather, various modifications may be made to the illustrated embodiments within the scope and range of equivalents of the claims and without departing from the invention. Also, the embodiment selected for illustration in the figures is not shown to scale and is not limited to the proportions shown.

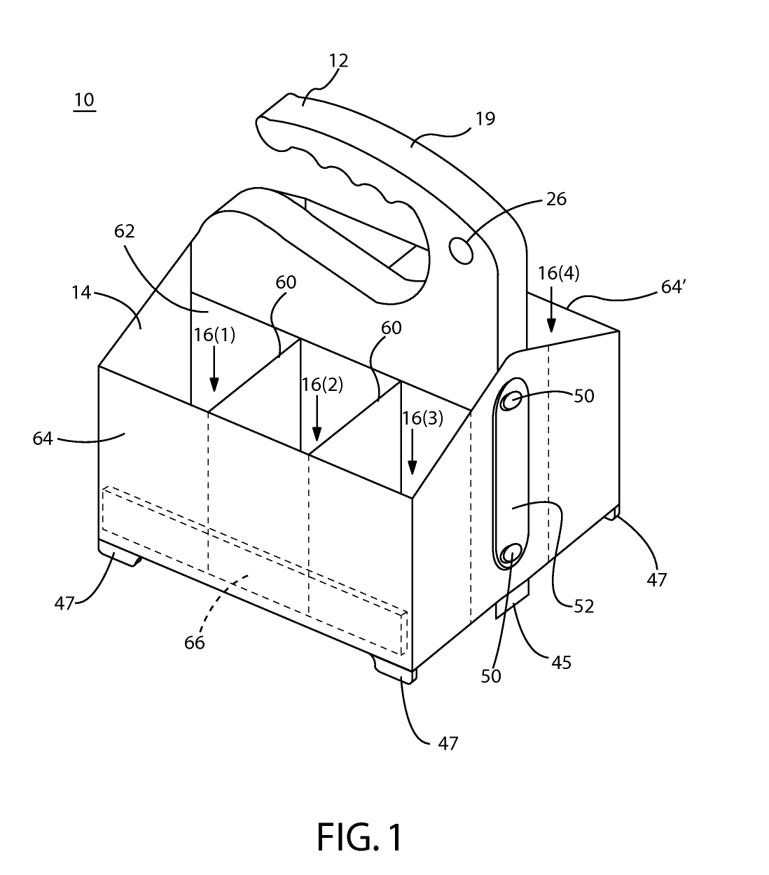

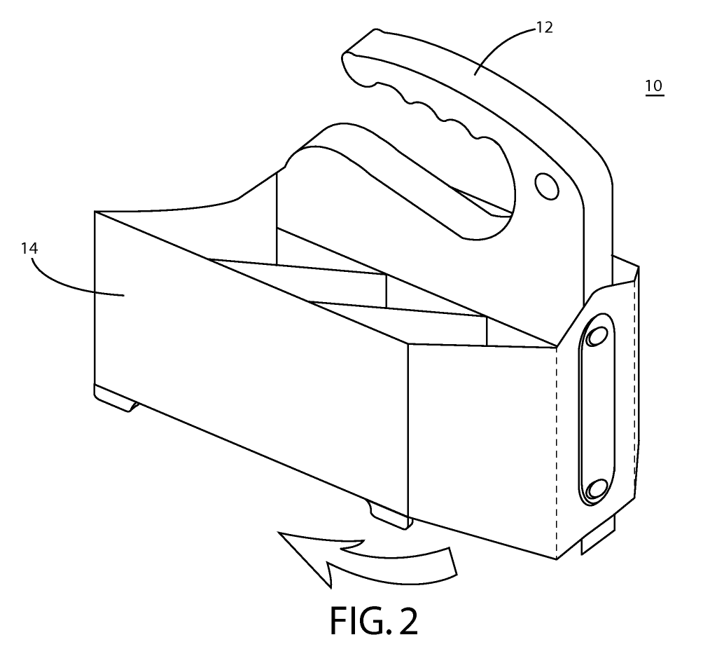

FIGS. 1-6 and 11 depict a beverage cooler according to an exemplary embodiment of the invention that is designated by item numeral 10. The beverage cooler 10 is an assembly that generally comprises a frame member 12 and a collapsible beverage housing 14 that is removably mounted to the frame member 12. The collapsible beverage housing 14 defines six separate and discrete beverage compartments 16(1) thru 16(6) (referred to collectively as compartments 16) that are each sized to receive a beverage container 3. The frame member 12 includes a internal cooling chamber for cooling the beverage containers that are positioned in the compartments 16 of the collapsible beverage housing 14. It should be understood that the size, shape and number of compartments 16 may vary from that shown and described herein without departing from the scope or the spirit of the invention.

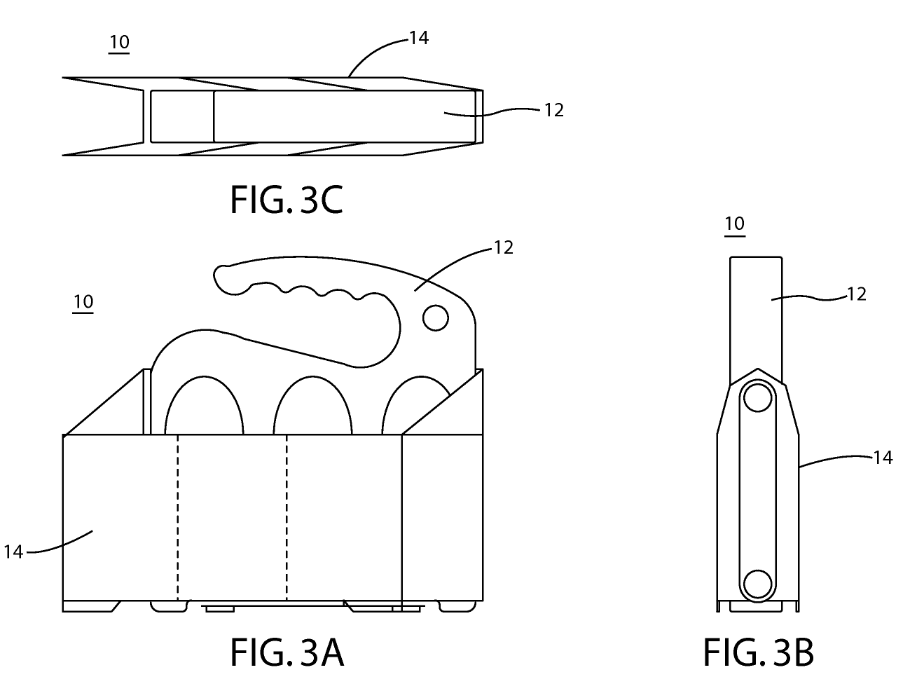

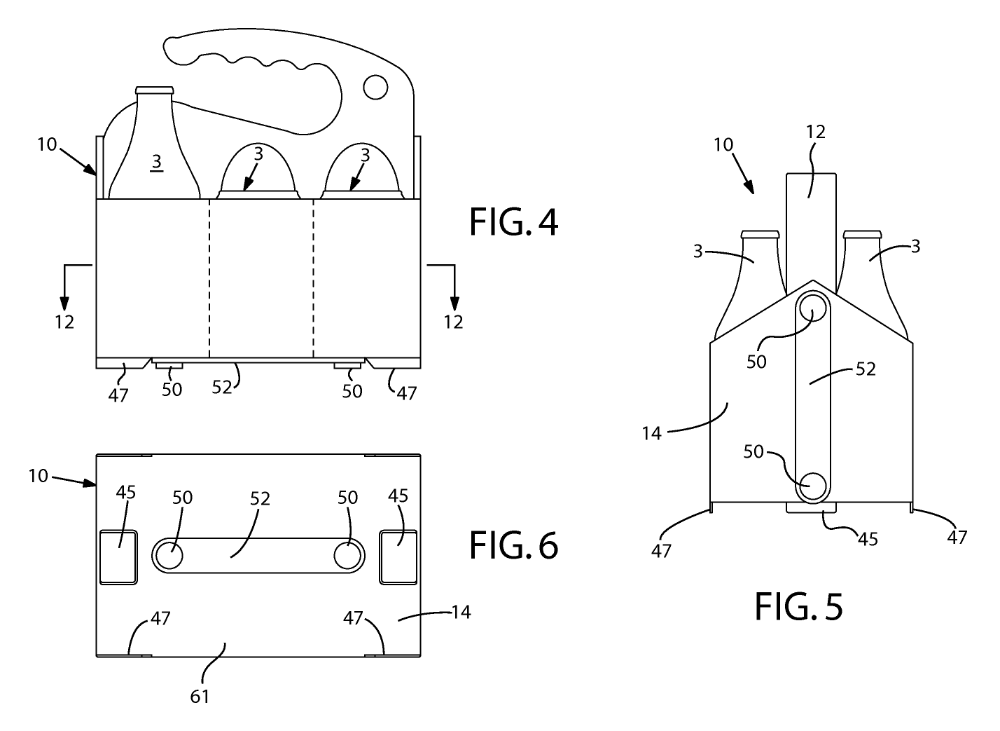

The collapsible beverage housing 14 of the beverage cooler 10 is movable between a deployed configuration (see FIG. 1) and a collapsed configuration (see FIGS. 3A-3C). As best shown in FIGS. 4, 5 and 11, in a fully-deployed configuration of housing 14, each compartment 16 is oriented to readily receive a beverage container 3, such as a glass bottle or an aluminum can. In a collapsed configuration, the cooler 10 can be conveniently stored in the refrigerator or freezer in a flat form to conserve space.

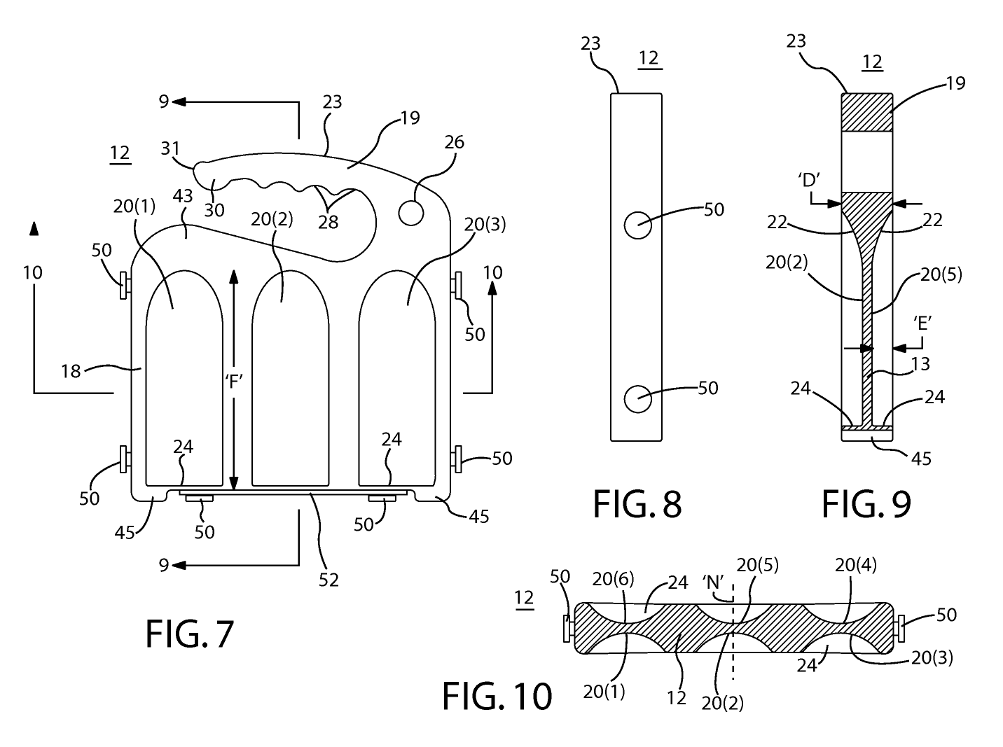

Referring now to FIGS. 7-10, the rigid frame member 12 has a unitary, i.e., one-piece, body. The body of the frame member 12 defines a substantially rectangular section 18 and a curved handle 19 extending from the rectangular section 18. The handle 19 is provided for grasping by a user of the cooler 10. An upwardly curving section 43 of the rectangular section 18, which is disposed beneath the handle 19, aids in evenly balancing the weight of the cooler 10 when the user is holding the handle 19.

The frame member 12 includes a hollow interior in which cooling liquid 13 is stored, similar to a conventional re-freezable ice pack. The cooling liquid 13 may be a combination of alcohol and water, for example, or just water. The cooling liquid 13 is distributed along the entire width of the frame member and along the portion of the height of the frame member 12 that is denoted by dimension ‘F’ (see FIG. 7). Dimension ‘F’ generally corresponds to the overall height of the recessed surfaces 20 of the frame member. The internal volume of the frame member 12 that is filled with cooling liquid 13 may be referred to herein as a cooling chamber of the frame member 12. While the cooling liquid 13 is not distributed within the handle 19, the handle may be modified to incorporate cooling liquid. Although not shown, a removable cap may be provided on the frame member 12 to enable the delivery of the cooling liquid 13 into the hollow interior of the frame member 12.

The handle 19 may be hollow, or, alternatively, the handle 19 may be composed of solid material to enhance the rigidity of the frame member 12. The frame member 12 may be composed of a polymeric material, such as vinyl or high density polyethylene, and may be manufactured by a blow molding or injected molding process, for example. The material of the frame member 12 should be sufficiently robust to withstand freezing of the cooling liquid 13 without resulting in cracking, deformation or distortion of the frame member 12. Those skilled in the art will recognize that the frame member 12 may be composed of a variety of different materials and produced by a variety of different manufacturing processes than those described herein without departing from the scope or the spirit of the invention.

Six internally recessed surfaces 20(1) thru 20(6) (referred to collectively as recessed surfaces 20) are defined on the rectangular section 18 of the frame member 12. Three recessed surfaces 20 are defined on the front side of the frame member 12 and three recessed surfaces 20 are defined on the rear side of the frame member 12, as shown in FIG. 10. Each recessed surface 20 generally corresponds in position to a compartment 16 of the beverage housing 14. The recessed surfaces 20 help maintain the beverage containers in a substantially fixed position. As best shown in FIG. 12, each recessed surface 20 comprises a rounded concave surface that is sized to receive a side surface of a beverage container 3 in a form fitting manner in order to transfer thermal energy to the beverage container 3. The diameter of each recessed surface 20 is slightly larger than the diameter of a conventional beverage container 3. The depth ‘E’ (see FIG. 9) of each recessed surface 10 is significantly less than the diameter of a conventional beverage container 3 and may be about 0.4 inches, for example.

As best shown in FIG. 9, a rounded surface 22 is formed at the top end of each recessed surface 20. Alternatively, each recessed surface 20 may extend further towards the top edge 23 of the frame member, or even intersect the top edge 23 of the frame member 12. As yet another alternative, each rounded surface 22 may extend to the bottom surface of the frame member 12. Each recessed surface 20 intersects a flat surface 24 that is sized to receive at least a portion of a bottom edge of a beverage container (not shown). In use, the bottom edge of the beverage container rests against the flat planar surface 24. The flat surface 24 prevents the beverage container from directly striking any surface upon which the cooler 10 is placed. The flat planar surface 24 also provides cooling to the bottom edge of the beverage container. In an exemplary embodiment, the flat surface 24 does not provide cooling and the portion of the frame member 12 corresponding to the flat surface 24 is solid and the cooling chamber does not extend under the flat surface 24. It should be understood the size, shape and number of recessed surfaces 20 may vary from that shown and described herein without departing from the scope or the spirit of the invention.

According to one aspect of the invention, with the exception of the recessed surfaces 20, the thickness dimension ‘D’ of the frame member 12 is substantially uniform. The thickness of the frame member 12 may be about 1.44 inches, for example. By virtue of the substantially uniform thickness, the cooler 10 can be conveniently stored in the refrigerator or freezer in a flat form to conserve space. Additionally, coolers 10 can also be conveniently stacked and hung on a hook via aperture 26 to conserve space.

Referring now to the features of the handle 19 of the frame member 12, the handle 19 extends from one side of the rectangular section 18. The terminal end 31 of the handle 19 extends past the central axis ‘N’ of the rectangular section 18. The handle 19 includes four grooves 28 for grasping by a user of the cooler 10. The grooves 28 provides a user with more comfort as compared with a handle devoid of grooves. The terminal end 31 of the handle 19 defines an oval-shaped, bulbous, enlarged section 30 that has a greater diameter than the rest of the handle bar 19. The position of the enlarged section 30 is tailored such that a cooler 10 populated with beverages 3 is level when hung by the handle 19. Additionally, the enlarged section 30 substantially prevents a users hand from inadvertently sliding off of the terminal end 31 of the handle 19. At least a portion of the handle 19 is rounded to provide strength and uniformed smoothness.

An opening 26 is defined in the frame member 12 at a location where the handle 19 meets the rectangular section 18. Opening 26 is sized to receive a hook therethrough, such as a hook positioned in a freezer compartment at a convenience store. By virtue of the location of opening 26 and the effects of gravity, the housing 14 automatically adjusts to a collapsed configuration when it is hung from a hook. The cooler 10 may be hung using a snap hook or a string, for example.

Referring now to FIGS. 1 and 6, two feet 45 are disposed on the bottom side of the frame member 12. Four feet 47 protrude from the bottom side corners of the beverage housing 14. The feet 45 and 47 assist in maintaining the beverage cooler in an upright position.

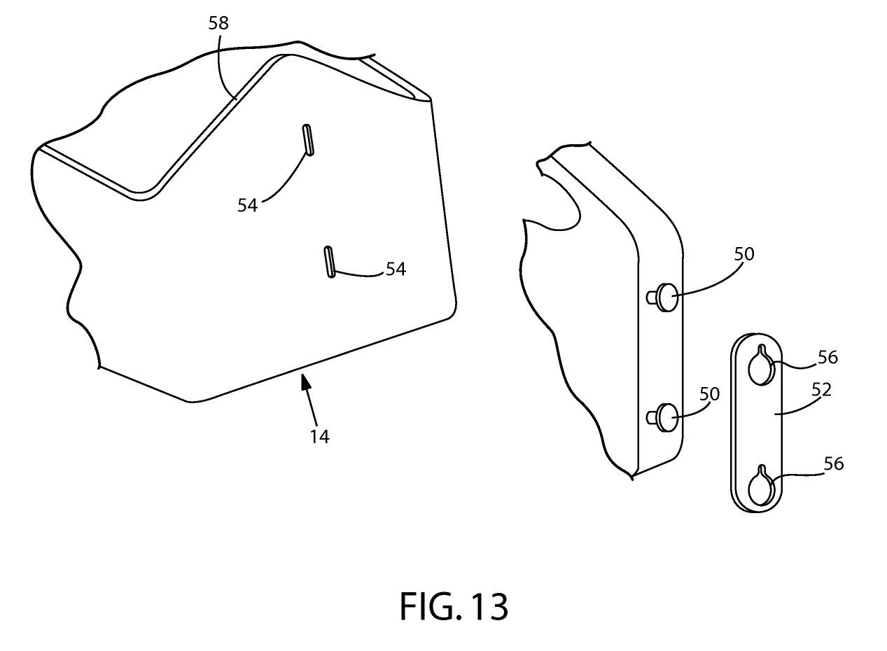

Referring now to FIGS. 7 and 13, the right, left and bottom side surfaces of the frame member 12 each includes two buttons 50 that releasably mate with apertures 54 defined on the right, left and bottom side surfaces of the beverage housing 14. The buttons 50 are integrated into the frame member 12. Alternatively, the buttons 50 may be separate components that are mounted to the frame member 12.

Three lock tabs 52 are provided in the form of rectangular strips of vinyl material for securing the beverage housing 14 to the frame member 12. Each removable lock tab 52 includes two slotted holes 56 for mating with the buttons 50.

To assemble the beverage housing 14 onto the frame member 12, the buttons 50 are positioned through the apertures 54 on the right, left and bottom side surfaces of the housing 14. Thereafter, the lock tab 52 is removably secured over the protruding buttons 50 on the right, left and bottom side surfaces of the frame member 12. Those skilled in the art will recognize that other mechanisms may be employed to secure the beverage housing 14 to the frame member 12 without departing from the scope or the spirit of the invention.

Referring back to FIG. 1, the beverage housing 14 is substantially rectangular in shape. The beverage housing 14 defines six collapsible compartments 16 that are each sized to receive a beverage container. Each compartment 16 comprises five interconnected walls of material, i.e., a horizontal bottom wall and four vertical side walls. In an exemplary embodiment, the perimeter walls including walls 63, 63′, 64 and 64′ of the housing 14 are comprised of single sheet comprising one or more layers. The bottom wall 61 minimizes the flow of cool air out of the bottom the compartments 16 and improves the cooling capability of the cooler 10. In an exemplary embodiment, one of the vertical side walls of each compartment 16 is formed by the recessed surface 20 of the frame member 12. Apertures are defined on the surfaces of the housing 14 to accommodate the feet 45 and the buttons 50 of the frame member 12. Additional material in the form of triangular sections 58 extend from the right and left sides of the beverage housing 14. The triangular sections 58 prevent the material of the housing 14 at the top positioned apertures 54 from tearing under the weight of the beverage containers.

According to one aspect of the invention, the beverage housing 14 includes two material layers that are stitched or otherwise coupled or bonded together. Each material layer of the beverage housing 14 is sufficiently flexible to permit the cooler 10 to easily move from a deployed position to a collapsed position, and vice versa. The material layers of the beverage housing 14 may be glued, stitched, fastened or fused together to form a single integrated unit. While the beverage housing 14 is described as having two material layers hereinafter, those skilled in the art will recognize that the housing 14 may have any number of material layers.

The outermost layer of the beverage housing 14 is formed from a cloth or cotton material. The outermost material layer may also be formed from an insulative material. As another alternative, the outermost layer may be formed from an elastomeric material, such as a neoprene material, for example, that is configured to bias the beverage containers 3 against the frame member 12 to effect heat transfer between the beverage containers 3 and the cooling chamber of the frame member 12. The outermost layer may be composed of a material that is washable. Although not shown, the lock tab 52 may be integrally connected to the outermost layer, as opposed to being a separate component. Those skilled in the art will recognize that the beverage housing 14 may be formed from a variety of materials without departing from the scope or the spirit of the invention.

The innermost layer of the beverage housing 14 is composed of a thermally insulative material, such as foam. The insulation material retains the cold thermal energy radiated from the frame member 12. Alternatively, the innermost layer of material may be composed of a thermally conductive material to distribute the cold thermal energy around the entire circumference of the beverage containers 3. The innermost layer of the beverage housing 14 may be omitted where the housing 14 is positioned in direct contact with the frame member 12. Those skilled in the art will recognize that the innermost layer of the beverage housing 14 may be formed from a variety of materials without departing from the scope or the spirit of the invention.

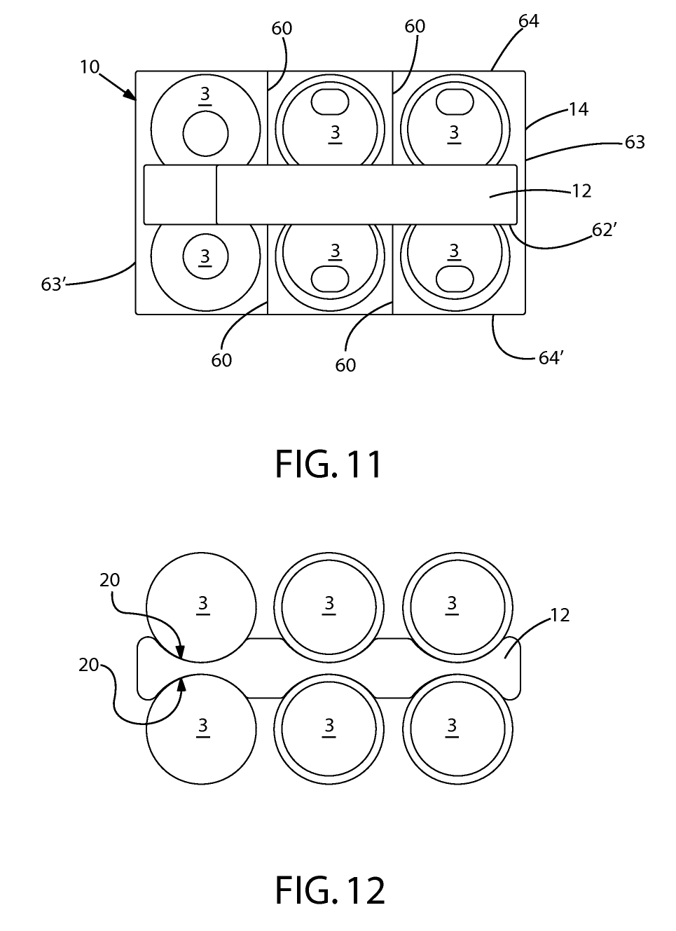

As best shown in FIGS. 1 and 11, two material walls 60 extend between the medial wall 62 and the lateral wall 64 on the front side of the beverage housing 14, and two material walls 60 extend between the medial wall 62′ and the lateral wall 64′ on the rear side of the beverage housing 14. The walls 60 form the side walls of the compartments 16 and prevent the beverage containers from contacting each other. Each wall 60 may be formed from a relatively thin material so as not to effect the overall thickness of the cooler 10 in its collapsed form. The walls 60 may be glued, stitched, fused, fastened, or otherwise connected to the medial wall 62 and the lateral wall 64.

Two rectangular-shaped rigid sheets 66 (shown in broken lines in FIG. 1) may be positioned at the lower end of the front and rear lateral walls 64, 64′. In an exemplary embodiment, the sheets 66 are interposed between the innermost and outermost material layers of the beverage housing 14. One sheet 66 is positioned at the lower end of the front lateral wall 64 and the other sheet 66 is positioned at the lower end of the rear lateral wall 64′. The sheets 66 may be glued, stitched, fused, fastened, or otherwise connected to the innermost and/or outermost layers of the housing 14. The sheets 66 are each formed from a rigid material such as plastic, for example. In an exemplary embodiment, the front and rear lateral walls 64, 64′ are made of plastic and the sheets 66 are an integral part of the front and rear lateral walls 64, 64′.

Two feet 47 are formed on the lower corners of each rigid sheet 66. Each foot 47 protrudes through an aperture formed in the outermost layer of the housing 14. In use, the cooler 10 rests on feet 45 and 47 thereby preventing damage to the underside of the outermost layer of the housing 14.

The sheets 66 provide rigidity, structure, and support to the cooler 10 when beverages are positioned inside the compartments 16 as well as when the cooler 10 is collapsed. Additionally, by virtue of the rigid sheets 16, the walls of the housing 14 automatically collapse and fold in one motion.

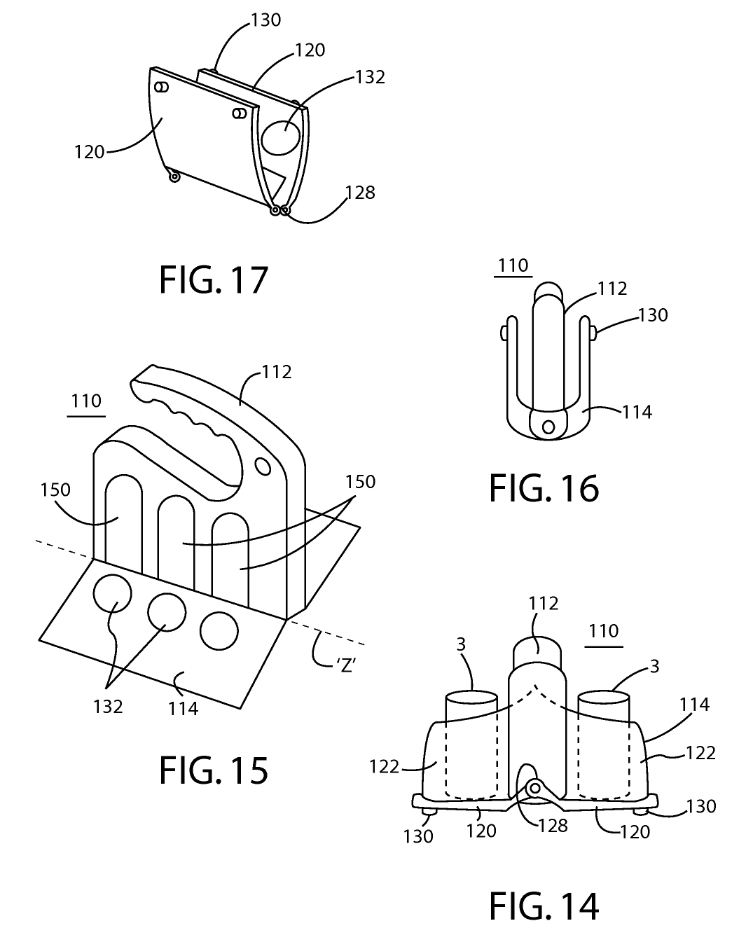

FIGS. 14-17 depict another exemplary embodiment of a beverage cooler that is designated by item numeral 110. The beverage cooler 110 is substantially similar to the beverage cooler 10, and only the differences between those coolers will be described hereinafter.

The collapsible beverage housing 114 includes two hinged members 120 and material 122 coupled to the hinged members 120. The material 122 may also be coupled to the frame member 112. Like the beverage housing 14 of FIG. 1, the material 122 defines the individual beverage compartments.

The hinged members 120 are coupled together by a pin to form a hinge 128. The hinge 128 is mounted to the right and left sides of the frame member 112. By virtue of the hinge 128, the collapsible beverage housing 114 is capable of folding between the retracted configuration shown in FIG. 16 and the deployed configuration shown in FIG. 14. The axis of rotation of the hinged members 120 is parallel to a central axis ‘Z’ of the frame member 112. Feet 130 are located on a lower surface of each hinged member 120 for resting against a surface.

In an exemplary embodiment, each hinged member 120 includes three recessed surfaces 132 formed on a top side thereof. The bottom surface of the beverage container 3 rests within recessed surfaces 132. Unlike the frame member 12 of the beverage cooler 10, the frame member 112 of the beverage cooler 110 does not include a flat surface (like surface 24) upon which the edge of the beverage container 3 rests. Like the cooler 10, however, the sides of the beverage containers 3 bear on the recessed surfaces 150 formed on the frame member 112 to enable heat transfer between the frame member 112 and the beverage containers 3.

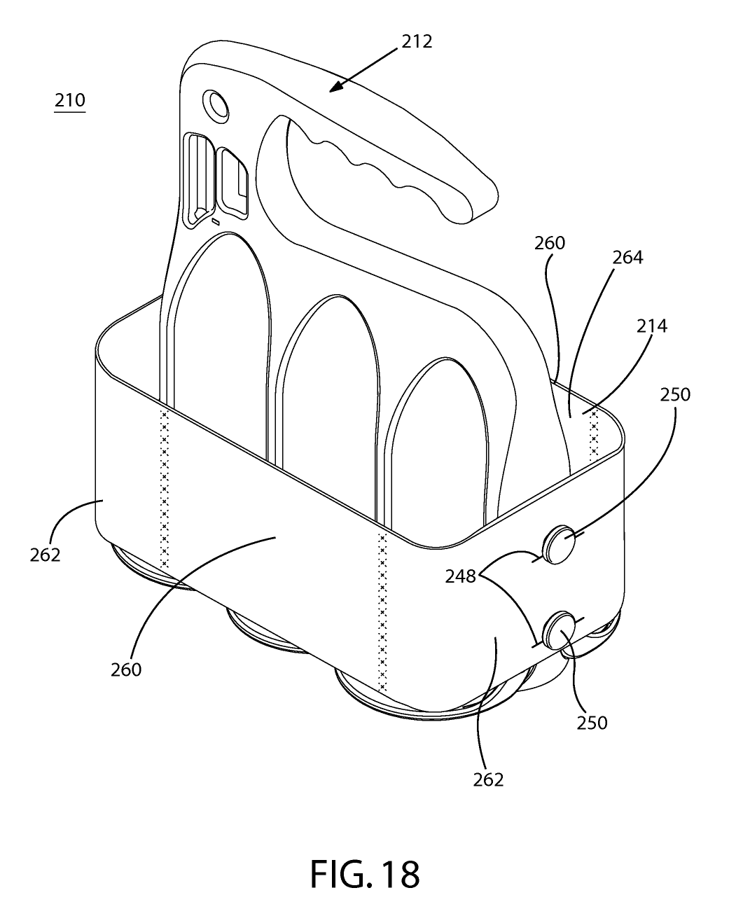

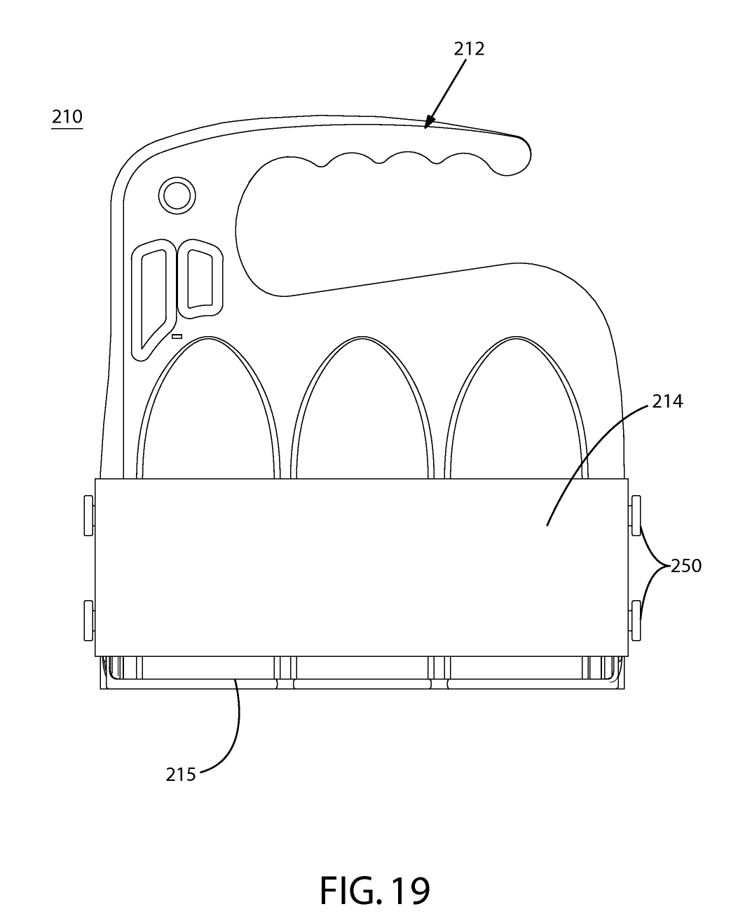

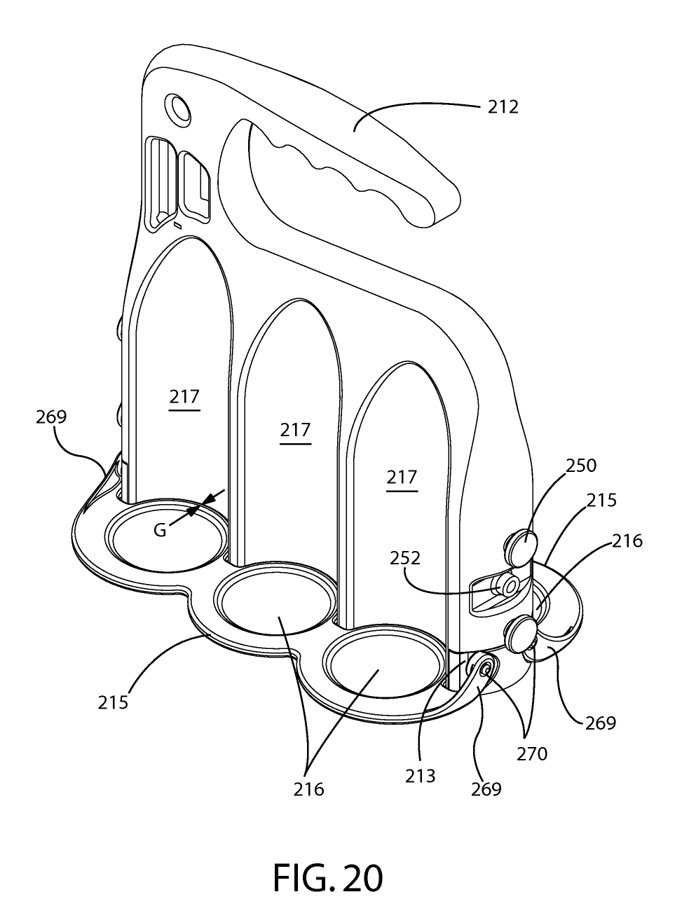

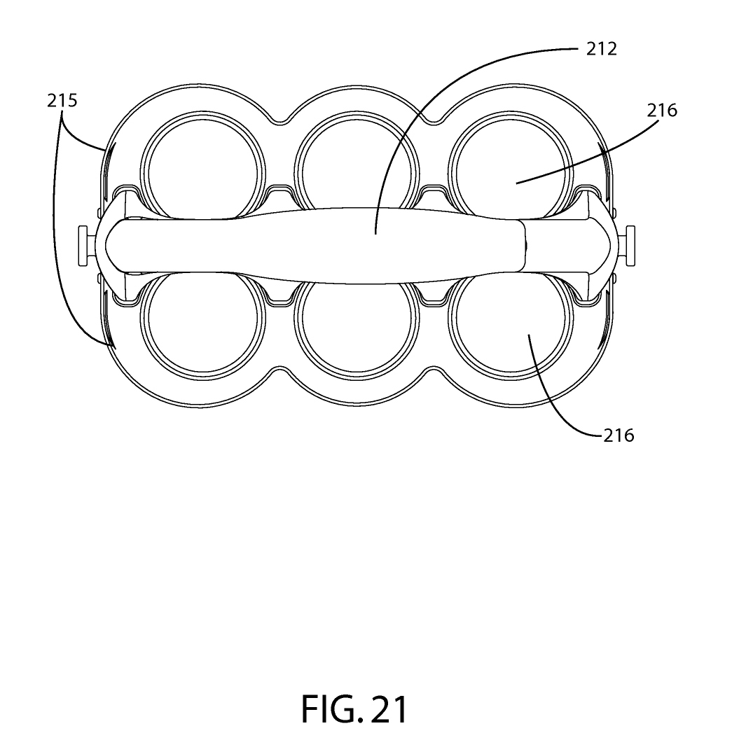

Referring now to FIGS. 18-22, FIGS. 18 and 19 depict another exemplary embodiment of a beverage cooler that is designated by item numeral 210, and FIGS. 20-22 depict a partially-assembled beverage cooler (i.e., the beverage cooler 210 without an elasticized strap 214). The beverage cooler 210 is substantially similar to the beverage cooler 110, and differences between those coolers will be described hereinafter.

The beverage cooler 210 includes a frame member 212 having an internal cooling chamber that is capable of containing a cooling medium, an elasticized strap 214 that is removably mounted to the frame member 212 to retain beverage containers adjacent to the frame member 212, and two independently movable beverage support members 215 that are pivotably mounted with respect to the frame member 212 to support the bottom end of the beverage containers.

The front and rear sides of the frame member 212 each include three recessed surfaces 217. Each recessed surface 217 is positioned to receive at least a portion of a side surface of a beverage container. Accordingly, the radius of each recessed surface 217 is sized to correspond to the radius of a conventional beverage can and/or beverage bottle.

Two beverage support members 215 are mounted toward the bottom end of the frame member 212. Each beverage support member 215 is configured to accommodate three beverage containers. Each beverage support member 215 defines three slightly recessed beverage support surfaces 216 that are each sized to support and retain the bottom end of a single beverage container. Those skilled in the art will recognize that the beverage support member 215 may be modified to accommodate any number of beverage containers and may not have any recessed beverage support surfaces 216.

Each beverage support member 215 includes two opposing mounting arms 269 that are mounted to the frame member 212 by pins 270, protrusions, fasteners, hinges or any other mechanism that facilitates rotation of support member 215. The right and left sides of the frame member 212 include a recessed region 213 to accommodate rotation of the mounting arms 269 without interfering with the strap 214. The recessed region 213 is configured to limit the rotation of the support member 215 between the vertical and horizontal positions.

In a deployed position of a support member 215, its beverage support surfaces 216 are substantially horizontal and positioned to support beverage containers (see support member 215 in FIG. 20). More particularly, in the deployed position, the bottom surface of a beverage container can be seated against the recessed surface 216 while the side surface of the beverage container contacts the recessed surface 217 of the frame member 212. The strap 214 urges the side surface of the beverage container against the cold recessed surface 217 of the frame member 212, thereby cooling the beverage container.

In a deployed position of a support member 215, the curvature of the support member 215 corresponds to the curvature of the recessed surfaces 217 of the frame member 212, such that at least a portion of the support members 215 (in its deployed position) are positioned within the recessed surfaces 217 of the frame member 212, as best shown in FIG. 20. The gap ‘G’ separating the boundary of the recessed surface 216 and an adjacent recessed surface 217 of the frame member 212 is sized to ensure that the side surface of a beverage container contacts the recessed surface 217 of the frame member 212 when the bottom surface of that beverage container is seated within the recessed surface 216 of the support member 215. The gap ‘G’ may be omitted.

In the deployed position of the support member 215, a bottom surface of the beverage support member 215 is flush with a bottom surface of the frame member 212, such that the bottom surfaces of the support member 215 and the frame member 212 may be placed on a level surface, such as a table. Alternatively, mounting feet may extend from the bottom surface of the beverage support member 215 and/or the bottom surface of the frame member 212, such as shown in FIG. 1.

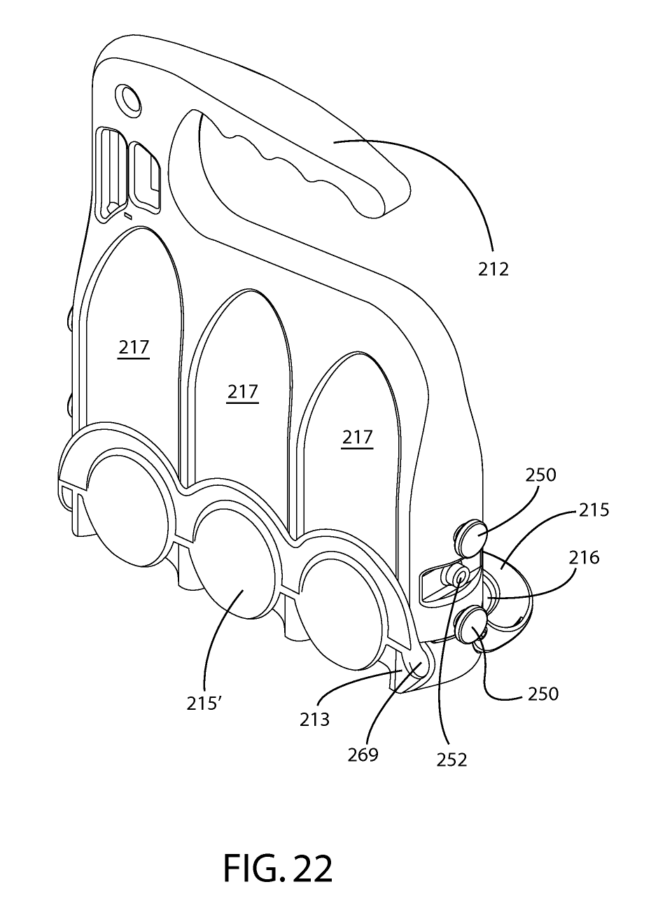

In a retracted position of a support member 215, its beverage support surfaces 216 are substantially vertical and, accordingly, are not positioned to support beverage containers (see vertical support member 215′ in FIG. 22). It is envisioned that the beverage support members 215 will be pivoted to the retracted positioned when stored on a shelf or stored in a refrigerator or freezer in the interest of conserving space. In the retracted position, the support member 215 is not positioned within the recessed surfaces 217 of the frame member 212. When the beverage support members 215 are rotated to the retracted position, the beverage cooler 210 has a substantially constant width along its entire length (with the exception of the recessed surfaces 217). The wall thickness of each support member 215 is minimized, such that the support members 215 do not dramatically increase the width of the beverage cooler 210 when they are in a retracted position.

The elasticized strap 214 urges the side surfaces of beverage containers into direct contact with the recessed surfaces 217 of the frame member 212. As best shown in FIG. 18, the strap 214 is composed of two cloth sheets 260, two elastic sheets 262 and two thermal insulation sheets 264 that are stitched, or otherwise connected together, to form elasticized strap 214. Each thermal insulation sheet 264 is stitched, or otherwise connected, to a beverage facing surface of a cloth sheet 260. Each elastic sheet 262 is stitched, or otherwise connected, to opposing ends of the cloth sheets 260.

The elasticized strap 214 is removably mounted to the frame member 212 by four buttons 250 that are provided on the right and left sides of the frame member 212. Each elastic sheet 262 includes two button-receiving openings 248 for releasably receiving buttons 250 that are provided on the frame member 212.

Alternatively, the strap 214 may be a single unitary component formed from an insulative material having elastic properties, or vice versa. As another alternative, the strap 214 may comprise a single elastic band having an insulative material that is stitched, or otherwise attached, to at least a portion of the interior surface of the strap that faces the beverages. As yet another alternative, a collapsible beverage housing having multiple compartments, i.e., similar to the housing 14 of FIG. 1, may be mounted to the frame member 212 in lieu of the strap 214 without departing from the scope or spirit of the invention.

The frame member 212 includes a hollow interior in which cooling liquid is stored, similar to a conventional re-freezable ice pack. The cooling liquid may be a combination of alcohol and water, for example, or just water. As shown in FIG. 22, a fluid port 252 is provided between the buttons 250 on the right side of the frame member 212. Cooling liquid is introduced into the interior region of the frame member 212 or expelled from the interior region via fluid port 252. The fluid port 252 is recessed into the side wall of the frame member 212 such that it does not interfere with the strap 214.

The ornamental aspects of the cooler 210 are protected in a co-pending design patent application.

Although illustrated and described above with reference to certain specific embodiments, the present invention is nevertheless not intended to be limited to the details shown. Rather, various modifications may be made in the details within the scope and range of equivalents of the claims and without departing from the spirit of the invention.

What is claimed:

1. A beverage cooler comprising:
a frame member including a cooling chamber defined within at least a portion of the frame member; and
a beverage support surface that is mounted with respect to the frame member for movement between a deployed position and a retracted position, wherein in the deployed position of the beverage support surface, the beverage support surface is positioned to support at least one beverage container, and in the retracted position of the beverage support surface, the beverage support surface is not positioned to support at least one beverage container.

2. The beverage cooler of claim 1 further comprising a beverage housing mounted to the frame member that is configured to retain beverage containers adjacent to the frame member.

3. The beverage cooler of claim 1 further comprising a collapsible beverage housing mounted to the frame member that defines a plurality of separate compartments that are each sized to contain a beverage container, wherein the beverage housing is movable between a deployed position in which each compartment is oriented to receive a beverage container and a collapsed position.

4. The beverage cooler of claim 1 comprising two independent beverage support surfaces that are each mounted with respect to the frame member for movement between respective deployed and retracted positions.

5. The beverage cooler of claim 4 further comprising separate pins pivotably securing each beverage support surface to the frame member.

6. The beverage cooler of claim 5 wherein the beverage support surfaces are positioned on opposite sides of the frame member.

7. The beverage cooler of claim 1, wherein in the deployed position of the beverage support surface, the beverage support surface is substantially horizontal, and in the retracted position of the beverage support surface, the beverage support surface is substantially vertical.

8. The beverage cooler of claim 1, wherein the beverage support surface is mounted to the frame member by a pin.

9. The beverage cooler of claim 1, wherein the beverage cooler has a substantially constant width along its entire length when the beverage support surface is in a retracted position.

10. The beverage cooler of claim 1, wherein the frame member defines a plurality of recessed surfaces that are each sized to receive at least a portion of a side surface of a beverage container.

11. The beverage cooler of claim 1, wherein the beverage support surface is at least partially positioned within one or more complimentary recesses formed in the frame member.

12. The beverage cooler of claim 1, wherein the beverage support surface is defined on a beverage support member and a bottom surface of the beverage support member is flush with a bottom surface of the frame member when the beverage support surface is maintained in the deployed position.

13. The beverage cooler of claim 1 further comprising an elasticized strap mounted to the frame member that is configured to retain beverage containers adjacent to the frame member.

14. The beverage cooler of claim 1, wherein the beverage support surface is a recessed surface that is defined on a beverage support member.

15. A method of assembling a beverage cooler comprising the step of mounting a beverage support surface onto a frame member of the beverage cooler for movement between a deployed position and a retracted position, wherein in the deployed position of the beverage support surface, the beverage support surface is positioned to support at least one beverage container, and in the retracted position of the beverage support surface, the beverage support surface is not positioned to support at least one beverage container.

16. The method of claim 15, wherein the mounting step comprises rotatably mounting the beverage support surface onto the frame member of the beverage cooler.

17. The method of claim 15 further comprising the step of delivering fluid into at least a portion of the frame member of the beverage cooler.

18. The method of claim 15 further comprising the step of mounting an elasticized strap to the frame member of the beverage cooler, wherein the elasticized strap is configured to retain the at least one beverage container against the frame member of the beverage cooler.

19. The method of claim 15 further comprising the step of mounting a beverage housing to the frame member that is configured to retain the at least one beverage container adjacent to the frame member.
